(19) United States
(12) Patent Application Publication
(10) Pub. No.: US 2026/0219729 A1
(43) Pub. Date: Jul. 30, 2026

(54) METHOD, APPARATUS AND SYSTEM FOR DETERMINING RELATIVE POSE, AND DEVICE AND MEDIUM

(71) Applicant: BEIJING UNICORN TECHNOLOGY CO., LTD., Beijing (CN)

(72) Inventors: Can Huang, Beijing (CN); Kejian Wu, Beijing (CN)

(21) Appl. No.: 19/144,499

(22) PCT Filed: Dec. 28, 2023
(86) PCT No.: PCT/CN2023/142967

§ 371 Date: Jun. 29, 2025

(30) Foreign Application Priority Data
Dec. 30, 2022 (CN) 202211731426.5
Feb. 14, 2023 (CN) 202310148409.7

(51) Int. Cl. G06F 3/01; G02B 27/01; G06T 7/33; G06T 7/73; G06V 10/74; G06V 10/77

(52) U.S. Cl. CPC G06F 3/012; G02B 27/017; G06T 7/344; G06T 7/73; G06V 10/761; G06V 10/7715; G06T 2207/30244

(57) ABSTRACT

Embodiments of the present disclosure disclose a method and apparatus for determining a relative pose, a system, a device and a medium. A specific implementation solution is as follows: at a current time, acquiring a current image, first inertial data, and second inertial data respectively by an image sensor, a first inertial measurement unit, and a second inertial measurement unit; predicting a first pose of the head-mounted display device relative to a carrier at the current time based on the first inertial data, the second inertial data, and a historical pose of the head-mounted display device relative to the carrier at the previous time; predicting a second pose of the head-mounted display device relative to the carrier at the current time based on the current image and a pre-constructed offline map model of the carrier; and fusing the first pose with the second pose, and determining a relative pose of the head-mounted display device relative to the carrier at the current time.

The present disclosure claims priority to Chinese Patent Application Nos. CN202211731426.5 and CN202310148409.7, filed with the China National Intellectual Property Administration on Dec. 30, 2022, and Feb. 14, 2023, respectively, and entitled “Method and Apparatus for Determining Relative Pose, System, Device, and Medium”, which is incorporated herein by reference in its entirety.

### TECHNICAL FIELD

The present disclosure relates to extended reality technology, and in particular, to a method and apparatus for determining a relative pose, a system, a device, and a medium.

### BACKGROUND

At present, extended reality technology has been widely applied to various fields such as healthcare, retail, education, social media, and entertainment, to enhance user experience.

Extended reality, which may include augmented reality, virtual reality, mixed reality, etc., provides a user with an extended reality experience by integrating rendered virtual content with a physical world, and allows the user to interact with a real or physical environment that is augmented by using the virtual content.

When the user wears a head-mounted display device based on extended reality technology in a movable carrier (e.g., an automobile), there is relative movement between the head-mounted display device and the carrier due to a difference in motion states between the user and the carrier.

In the related art, typically, a relative pose of the head-mounted display device relative to the carrier is determined based on a difference between inertial measurement values received from an inertial measurement device on the head-mounted display device and an inertial measurement device provided on the carrier, thereby characterizing the relative movement between the head-mounted display device and the carrier.

### SUMMARY

Embodiments of the present disclosure provide a method and apparatus for determining a relative pose, a stem, a device, and a medium.

In an aspect of embodiments of the present disclosure, there is provided a method for determining a relative pose, applied to a head-mounted display device, the head-mounted display device being provided with an image sensor, and the head-mounted display device being located inside a movable carrier, the method including: at a current time, acquiring a current image by the image sensor; predicting a second pose of the head-mounted display device relative to the carrier at the current time based on the current image and a pre-constructed offline map model of the carrier; and determining a relative pose of the head-mounted display device relative to the movable carrier based on the second pose.

In another aspect of embodiments of the present disclosure, there is provided an extended reality system including a head-mounted display device provided with an image sensor and an apparatus for determining a relative pose, wherein the apparatus for determining a relative pose determines a relative pose of the head-mounted display device relative to a carrier by using the method described in the above embodiments, and generates a projected image based on the relative pose.

The technical solution of the present disclosure is further described in detail below in conjunction with the accompanying drawings and embodiments.

### BRIEF DESCRIPTION OF THE DRAWINGS

The drawings constituting a part of the specification describe embodiments of the present disclosure, and together with the description, serve to explain the principle of the present disclosure.

With reference to the accompanying drawings, the present disclosure can be understood more clearly according to the following detailed description, in which:

FIG. 1 is a schematic structural diagram of an extended reality system in some embodiments of the present disclosure;

FIG. 2 is a schematic diagram of a scene to which a pose determination apparatus of the present disclosure is applicable;

FIG. 3 is a schematic flow diagram of some embodiments of a method for determining a relative pose in the present disclosure;

FIG. 4 is a schematic flow diagram of determining a second pose in some embodiments of the method for determining a relative pose in the present disclosure;

FIG. 5 is a schematic flow diagram of constructing an offline map model in some embodiments of the present disclosure;

FIG. 6 is a schematic diagram of a scene of obtaining a sample image and 3D coordinates of spatial points within a carrier in some embodiments of the present disclosure;

FIG. 7 is a schematic flow diagram of constructing an offline map model in other embodiments of the present disclosure;

FIG. 8 is a schematic flow diagram of determining an interior point and an exterior point in some embodiments of the present disclosure;

FIG. 9 is a schematic structural diagram of some embodiments of an apparatus for determining a relative pose in the present disclosure; and

FIG. 10 is a schematic structural diagram of some application embodiments of an electronic device in the present disclosure.

### DETAILED DESCRIPTION

Various exemplary embodiments of the present disclosure will now be described in detail with reference to the accompanying drawings. It is to be noted that unless specifically stated otherwise, the relative arrangement of components and steps, numerical expressions and numerical values set forth in these embodiments do not limit the scope of the present disclosure.

It may be understood by those skilled in the art that the terms “first”, “second” and the like in the embodiments of the present disclosure are only used to distinguish between different steps, devices or modules, etc., and do not represent any particular technical meaning or indicate an inevitable logical order thereof.

It should also be understood that in embodiments of the present disclosure, “plurality” may refer to two or more, and “at least one” may refer to one, two, or more.

It should also be understood that the number of any component, data, or structure mentioned in embodiments of the present disclosure may generally be understood to be one or more, unless explicitly defined or indicated otherwise by the context.

Additionally, the term “and/or” in the present disclosure merely represents an association relationship describing associated objects, indicating there may be three relationships. For example, A and/or B may indicate three situations: A exists alone; both A and B exist; and B exists alone. Additionally, the character “/” in the present disclosure generally indicates that the associated objects prior to and following it are in an “or” relationship.

It should also be understood that description of the various embodiments in the present disclosure emphasizes differences between the various embodiments. For their identical aspects or similarities, reference may be made to each other, and for the sake of brevity, they will not be described repeatedly.

Furthermore, it should be appreciated that, for ease of description, the sizes of various parts shown in the drawings are not drawn according to actual proportional relationships.

The following description of at least one exemplary embodiment is actually only illustrative, and in no way serves as any limitation on the present disclosure and its application or use.

Technologies, methods, and devices known to those of ordinary skill in the related art may be not discussed in detail, but where appropriate, the technologies, methods, and devices should be regarded as part of the specification.

It should be noted that similar reference numerals and letters denote similar items in the following drawings, so once a certain item is defined in one drawing, it does not need to be further discussed in subsequent drawings.

Embodiments of the present disclosure may be applied to electronic devices such as terminal devices, computer systems, servers, etc., which may operate with numerous other general-purpose or specialized computing system environments or configurations. Examples of well-known terminal devices, computing systems, environments, and/or configurations suitable for use with electronic devices such as terminal devices, computer systems, servers, etc. include, but are not limited to: personal computer systems, server computer systems, thin clients, thick clients, handheld or laptop devices, microprocessor-based systems, set-top boxes, programmable consumer electronics, network personal computers, minicomputer systems, mainframe computer systems, and distributed cloud computing technology environments that include any system described above, and so on.

Electronic devices such as terminal devices, computer systems, servers, etc. may be described in the general context of computer system executable instructions (such as program modules) executed by a computer system. Typically, program modules may include routines, programs, target programs, components, logic, data structures, and so on, which perform specific tasks or implement specific abstract data types. The computer systems/servers may be implemented in a distributed cloud computing environment, in which tasks are performed by remote processing devices linked through a communication network. In the distributed cloud computing environment, the program modules may be located on a local or remote computing system storage medium that includes a storage device.

The present disclosure provides a method, apparatus, system, electronic device, and computer-readable storage medium for providing an immersive extended reality experience in a movable carrier, to enable an extended reality system to distinguish between movement of a user and movement of the movable carrier in which the user is located, so that content of virtual images matches movement perceived by the user.

In some embodiments, a user device includes an inertial measurement unit configured to measure movement data of the user during the movement of the user. The user device further includes a pose (i.e., position and attitude) determination apparatus configured to receive inertial measurement values from the inertial measurement unit on the user device, and configured to receive inertial measurement values from an inertial measurement unit on the carrier in which the user is riding, wherein the inertial measurement device on the carrier moves synchronously with the carrier. The pose determination apparatus is configured to determine relative movement of the user device with respect to the carrier based on a difference between the inertial measurement unit on the user device and the inertial measurement unit on the carrier.

Since an inertial measurement device drifts over time, in order to avoid the impact of this phenomenon on pose accuracy, the drift of the inertial measurement device is corrected by means of real-time visual positioning in the related art. However, when the drift of inertial measurement device is corrected by real-time positioning, positions of feature points in a three-dimensional space need to be calculated simultaneously. In order to ensure real-time performance of data, the calculation accuracy of the data is often sacrificed, resulting in lower pose accuracy.

### Exemplary System

In some embodiments of the present disclosure, there is provided an extended reality system including a head-mounted display device, a target device, and a pose determination apparatus. The target device is configured at least to obtain motion data of a movable carrier. The movable carrier may include any type of transportation means or mobile environment, such as a vehicle, an airplane, a train, a vessel, an elevator, an amusement park ride, or the like.

Generally, the head-mounted display device includes at least a motion sensor and an image sensor.

The target device may be an integrated device, so that the target device may be integrated into the movable carrier. In this case, the target device may be regarded as a constituent of the movable carrier. The target device may also be a portable device, and may be fixed to the movable carrier by screwing, snap-fitting, plugging, or hook-and-loop fastening, etc., and the target device may be removable from the movable carrier. In this case, the target device may be regarded as a separate device. Regardless of whether the target device is integrated into the movable carrier or removably fixed to the movable carrier, it may be considered that the target device and the movable carrier are relatively stationary to each other, and that the target device and the movable carrier remain in the same state in a world coordinate system. Thus, motion data of the movable carrier may be obtained through the target device.

The pose determination apparatus may receive data from the motion sensor and the image sensor of the head-mounted display device, as well as motion data from an external sensor of the target device. The pose determination apparatus may estimate a posture of a user in the movable carrier relative to the carrier based on the received data, so that the head-mounted display device generates a projected image based on provided pose data, thereby providing an immersive extended reality experience.

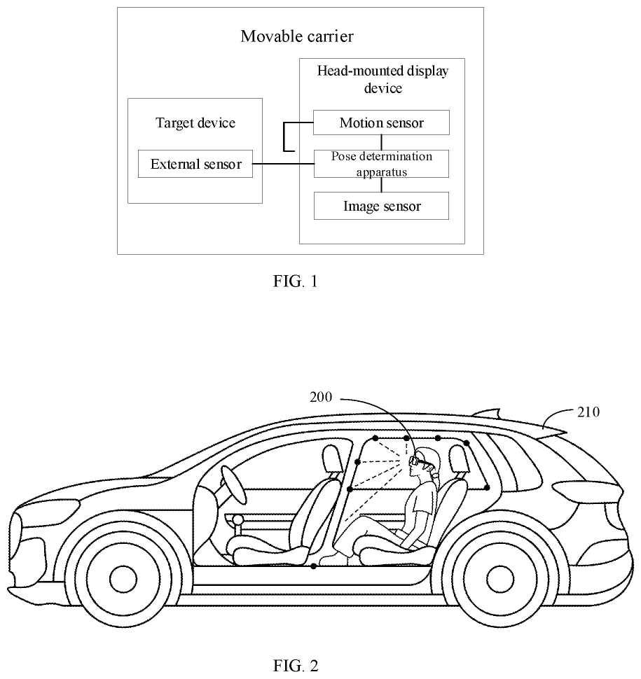

In optional embodiments, the pose determination apparatus may be integrated into the head-mounted display device, for example as shown in FIG. 1; or the pose determination apparatus may also be integrated within the movable carrier; or the pose determination apparatus is a separate device, and a wearer of the head-mounted display device may place the pose determination apparatus on any type of movable carrier.

In some embodiments, the pose determination apparatus may include: a data obtaining unit 910, a first prediction unit 920, a second prediction unit 930, and a pose determination unit 940. The data obtaining unit 910 may receive input data from one or more of the motion sensor and the image sensor on the head-mounted display device or the external sensor. Optionally, the motion sensor may be one or more inertial measurement units (IMUs), for acquiring inertial data of the head-mounted display device; the image sensor 960 may include any suitable type and number of camera, such as a depth camera, an RGB camera, or a combination thereof, for acquiring image data; and the external sensor may include a motion sensor mounted on the movable carrier, for acquiring inertial data of the movable carrier.

The first prediction unit 920 may be configured to predict a first pose of the head-mounted display device relative to the carrier at a current time based on the motion sensor, the external sensor, and a historical pose of the head-mounted display device at the previous time. The second prediction unit 930 may be configured to predict a second pose of the head-mounted display device relative to the carrier at the current time based on a current image and a pre-constructed offline map model of the carrier.

The pose determination unit 940 may be configured to fuse the first pose with the second pose, and determine a relative pose of the head-mounted display device relative to the carrier at the current time. Optionally, fusion calculation of the pose data may be performed by using an EKF algorithm (Extended Kalman Filter) or a Gauss-Newton optimization method, or may be modeled as a nonlinear least squares problem.

In such embodiments, the pose determination apparatus not only utilizes the real-time performance of the inertial data, but also corrects an adverse effect of inertial measurement drift on pose estimation by using the pre-established offline map model of the carrier, thereby increasing the accuracy of the relative pose, and helping improve a processing effect of subsequent image rendering based on the relative pose.

FIG. 2 illustrates a scene to which an extended reality system in some embodiments of the present disclosure is applicable. As shown in FIG. 2, a carrier 210 may be a vehicle. A head-mounted display device is provided with an image sensor (not shown in the figure) and a first inertial measurement unit (not shown in the figure), and the carrier 210 is provided with a second inertial measurement unit (not shown in the figure). The head-mounted display device 200 may move with the head of a wearer, and the image sensor provided thereon may acquire images in a field of view. The first inertial measurement unit and the second inertial measurement unit respectively acquire, in real time, first inertial data and second inertial data. A pose determination apparatus applied to the head-mounted display device 200 is configured to predict a first pose of the head-mounted display device relative to the vehicle at a current time based on the first inertial data, the second inertial data, and a historical pose of the head-mounted display device relative to the vehicle at the previous time, and predict a second pose of the head-mounted display device relative to the vehicle at the current time based on a current image and a pre-constructed offline map model, and then fuse the first pose and the second pose by using a multi-sensor fusion method, thereby determining a relative pose of the head-mounted display device 200 relative to the vehicle. In such embodiments, an adverse effect of inertial measurement drift on pose estimation is corrected by using the offline map model, and the accuracy of the relative pose is ensured under the premise of providing a real-time pose, which helps improve a processing effect of subsequent image rendering based on the relative pose, thereby improving the comfort of a user wearing the head-mounted display device in the movable carrier.

### Exemplary Method

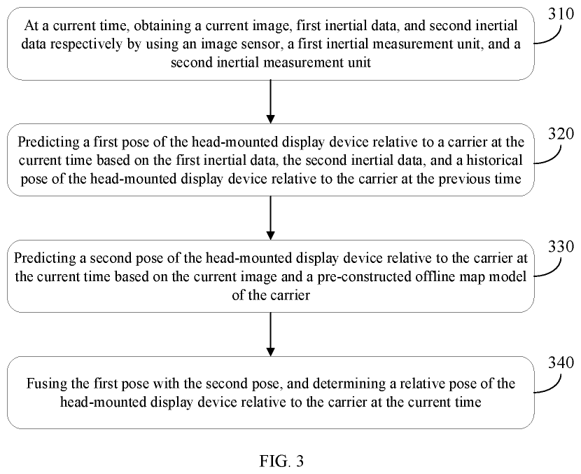

FIG. 3 illustrates a method for determining a relative pose in some embodiments of the present disclosure. As shown in FIG. 2, the method includes the following steps:

Step 310: at a current time, acquiring a current image, first inertial data, and second inertial data respectively by using an image sensor, a first inertial measurement unit, and a second inertial measurement unit.

In such embodiments, a head-mounted display device is provided with an image sensor and the first inertial measurement unit, and a carrier is provided with the second inertial measurement unit. When the head-mounted display device is located inside a movable carrier, the first inertial measurement unit may be used to acquire the first inertia data of the head-mounted display device, the image sensor may be used to acquire an image from a current viewing angle to obtain the current image, and the second inertia data of the carrier acquired by the second inertial measurement unit may be obtained. It may be understood that the current image photographed by the image sensor should include at least an image of part of an area inside the carrier.

As an example, the first inertial measurement unit and the second inertial measurement unit may be inertial measurement units (IMUs) which are respectively for acquiring inertial data of the head-mounted display device and the carrier. For example, the inertial data may be three-axis attitude angles and accelerations.

Step 320: predicting a first pose of the head-mounted display device relative to a carrier at the current time based on the first inertial data, the second inertial data, and a historical pose of the head-mounted display device relative to the carrier at the previous time.

As an example, a visual-inertial odometry may be constructed based on the first inertial data, the second inertial data, and the historical pose, thereby estimating the first pose of the head-mounted display device relative to the carrier at the current time.

step 330: predicting a second pose of the head-mounted display device relative to the carrier at the current time based on the current image and a pre-constructed offline map model of the carrier.

In such embodiments, the offline map model is a three-dimensional model pre-constructed based on a three-dimensional structure inside the carrier. For example, it may be in the form of a point cloud. Each point in the point cloud has known 3D coordinates and corresponds to one or more descriptors. The three-dimensional structure inside the carrier is characterized by the point cloud.

As an example, feature point matching may be performed between the 2D current image and the 3D offline map model to determine feature point pairs that are in a correspondence, and then the second pose of the head-mounted display device relative to the carrier may be predicted based on the correspondence of the feature point pairs and coordinates of feature points in the 3D offline map model.

Step 340: fusing the first pose with the second pose, and determining a relative pose of the head-mounted display device relative to the carrier at the current time.

As an example, the first pose may be fused with the second pose by using an EKF (Extended Kalman Filter) method or a Gauss-Newton optimization method or by constructing a nonlinear least squares problem, to correct an adverse effect of inertial measurement drift on pose estimation, thereby obtaining the relative pose of the head-mounted display device relative to the carrier at the current time.

In such embodiments, a first pose of the head-mounted display device relative to a carrier at a current time may be predicted based on the first inertial data, the second inertial data, and a historical pose of the head-mounted display device relative to the carrier at the previous time, and a second pose of the head-mounted display device relative to the carrier at the current time may be predicted based on the current image and a pre-constructed offline map model of the carrier, and then the first pose and the second pose are fused by using a multi-sensor fusion method. This not only utilizes the real-time performance of the inertial data, but also corrects an adverse effect of drift of the inertial measurement units on pose estimation by using the pre-established offline map model, thereby increasing the accuracy of the relative pose, and helping improve a processing effect of subsequent image rendering based on the relative pose.

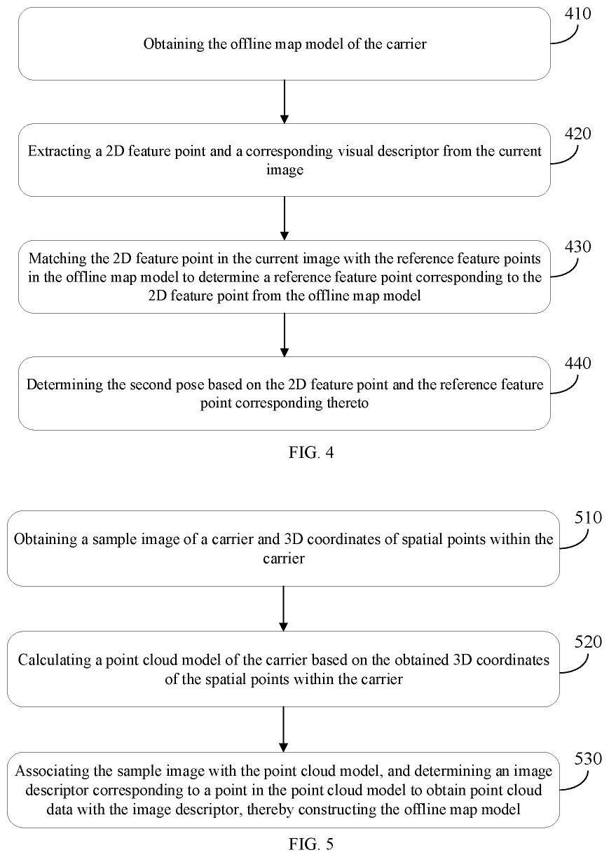

Next, reference is made to FIG. 4, which illustrates a schematic flow diagram of determining the second pose in some embodiments of the method for determining a relative pose in the present disclosure. As shown in FIG. 4, the process includes the following steps:

Step 410: obtaining the offline map model of the carrier.

The offline map model includes predetermined reference feature points of the carrier and reference visual descriptors thereof.

In such embodiments, the offline map model is a three-dimensional model pre-constructed based on a three-dimensional structure inside the carrier. The reference feature points therein may be three-dimensional key points in the three-dimensional structure inside the carrier, and one or more descriptors corresponding to each three-dimensional key point are the reference visual descriptors. The offline map model of the carrier may be pre-stored in the head-mounted display device, and when the offline map model needs to be obtained, it may be directly invoked from local storage space.

As an example, the offline map model may be a 3D point cloud of the carrier, each point in the 3D point cloud corresponding to one or more visual descriptors.

Step 420: extracting a 2D feature point and a corresponding visual descriptor from the current image.

In this embodiment, the 2D feature point is composed of two parts: a two-dimensional key point characterizing feature information of the current image and a descriptor. A key point is usually a representative point in an image, e.g., a corner point and an edge. The two-dimensional key point characterizes positional information of the feature point in the image. The descriptor is a data structure used to characterize the feature, and the descriptor is usually multidimensional.

As an example, the head-mounted display device may utilize an image recognition algorithm to identify representative 2D feature points from the current image and determine visual descriptors thereof. For example, a SIFT (Scale-Invariant Feature Transform) algorithm may be used to extract SIFT feature points and visual descriptors thereof from the current image; or a SURF (Speeded-Up Robust Features) algorithm (an accelerated robust detection algorithm) may be used to extract SURF feature points and visual descriptors thereof, or an ORB (Oriented FAST and Rotated BRIEF) algorithm (a feature point detection and extraction algorithm), a SuperPoint algorithm, etc. may be used.

Step 430: matching the 2D feature point in the current image with the reference feature points in the offline map model to determine a reference feature point corresponding to the 2D feature point from the offline map model.

In such embodiments, the reference feature points in the offline map model are three-dimensional feature points, and the 2D feature point in the current image is a two-dimensional feature point. A matching degree between the 2D feature point and a reference feature point may be characterized by a degree of similarity between a visual descriptor of the 2D feature point and a reference visual descriptor of the reference feature point, and a correspondence between the 2D feature point and the reference feature point may be determined thereby.

As an example, a multidimensional vector distance between the visual descriptor of the 2D feature point and a reference visual descriptor may be used. If the multidimensional vector distance between the visual descriptor of the 2D feature point and the reference visual descriptor is less than a preset distance threshold, the reference feature point described by the reference visual descriptor may be determined as a reference feature point corresponding to the 2D feature point.

In such embodiments, a degree of similarity between the visual descriptor of the 2D feature point and each reference visual descriptor may be determined first, and then a reference feature point corresponding to a reference visual descriptor with the highest degree of similarity may be determined as a reference feature point corresponding to the 2D feature point. This helps improve the efficiency and accuracy of the matching between the 2D feature point and the reference feature point.

Step 440: determining the second pose based on the 2D feature point and the reference feature point corresponding thereto.

As an example, the second pose may be determined by localizing the head-mounted display device based on two-dimensional coordinates of the 2D feature point in the current image, and three-dimensional coordinates of the corresponding reference feature point in the offline map model.

In such embodiments, based on the current image and the pre-constructed offline map model, a reference feature point, which is in the offline map model, corresponding to a 2D feature point in the current image is determined by determining a matching feature point pair based on visual descriptors, and a second pose of the head-mounted display device relative to the carrier is determined based on two-dimensional coordinates of the 2D feature point and three-dimensional coordinates of the corresponding reference feature point. This helps improve the accuracy of image-based determination of the relative pose, so as to facilitate subsequent use of the relative pose that is determined based on the image to correct data drift of the inertial measurement units, thereby improving the calculation accuracy of the relative pose.

FIG. 5 shows a schematic flow diagram of a method for constructing an offline map model provided in some embodiments of the present disclosure. As shown in FIG. 5, the method includes the following steps:

Step 510: obtaining a sample image of a carrier and 3D coordinates of spatial points within the carrier.

In such embodiments, the sample image and the 3D coordinates of the spatial points within the carrier may be acquired within the carrier by an acquisition apparatus. The acquisition apparatus includes, but is not limited to, the following combinations: a camera; a camera and a 3D scanning apparatus; and a camera and an inertial measurement apparatus.

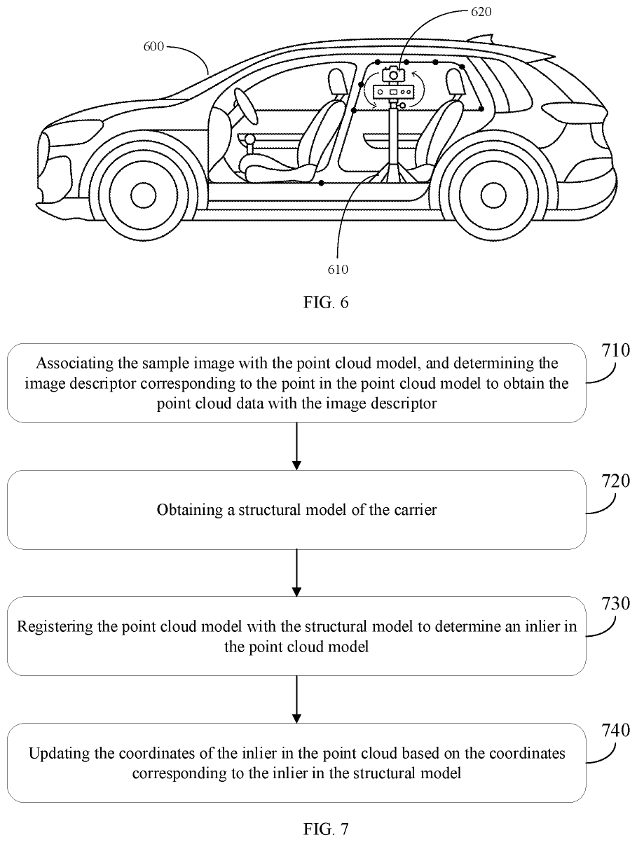

A method of obtaining a sample image and 3D coordinates of spatial points within a carrier is further illustrated exemplarily in conjunction with FIG. 6, which shows a schematic diagram of a scene in which 3D coordinates of spatial points within a carrier are acquired by an acquisition apparatus in some embodiments of the present disclosure. As shown in FIG. 6, a carrier 600 may be a vehicle, with a rotatable bracket 610 being provided inside the vehicle, and an acquisition apparatus 620 being fixed to the bracket 610. The bracket 610 may be used to drive the acquisition apparatus 620 to rotate for photography inside the carrier 600, to achieve scanning of an interior space of the carrier 600, thereby obtaining the sample image and the 3D coordinates of the spatial points.

Step 520: calculating a point cloud model of the carrier based on the obtained 3D coordinates of the spatial points within the carrier.

As an example, based on the 3D coordinates of the spatial points within the carrier, a point cloud generation algorithm (e.g., an open-source colmap algorithm) may be used to generate a sparse point cloud as the point cloud model of the carrier.

Step 530: associating the sample image with the point cloud model, and determining an image descriptor corresponding to a point in the point cloud model to obtain point cloud data with the image descriptor, thereby constructing the offline map model, wherein the point in the point cloud model and the image descriptor thereof are respectively used as a reference feature point and a reference visual descriptor. In such embodiments, by associating the sample image with the point cloud model, one or more image descriptors corresponding to the point in the point cloud model may be determined, and then the point in the point cloud model and the image descriptor thereof may be respectively used as a reference feature point and a reference visual descriptor, thereby constructing the offline map model.

The manner of generating the image descriptor may include, but is not limited to, the following: an ORB (Oriented FAST and Rotated BRIEF) algorithm (a feature point detection and extraction algorithm), a SIFT (Scale-Invariant Feature Transform) algorithm, a SURF (Speeded-Up Robust Features) algorithm (an accelerated robust detection algorithm), a SuperPoint algorithm, etc.

In such embodiments, a point cloud model of a carrier is generated based on 3D coordinates of spatial points within the carrier, and point cloud data with an image descriptor is generated by associating the point cloud model with a sample image of the carrier, and the offline map model is constructed thereby. This can ensure the accuracy in the offline map model.

In such embodiments, the sample image includes images obtained by photographing the carrier from a plurality of viewing angles and/or in a plurality of lighting environments. The above step 530 may include: determining image descriptors corresponding to the point in the point cloud model respectively from a plurality of viewing angles and/or in a plurality of lighting environments to obtain the point cloud data.

In such embodiments, when the 3D coordinates of the spatial points within the carrier are acquired by the acquisition apparatus, acquisition may be performed multiple times under different lighting conditions and from different acquisition viewing angles, to obtain coordinate data corresponding to multiple acquisition conditions, so that after the point cloud model is associated with the sample image, each point in the point cloud model may correspond to a plurality of image descriptors under different acquisition conditions. This helps improve the robustness of the offline map model under different conditions, so that the offline map model may be applied to different environments.

In some optional implementations of the present disclosure, the above step 530 may further include a process of constructing an offline map model as shown in FIG. 7. As shown in FIG. 7, the process includes the following steps:

Step 710: associating the sample image with the point cloud model, and determining the image descriptor corresponding to the point in the point cloud model to obtain the point cloud data with the image descriptor.

Step 720: obtaining a structural model of the carrier.

In such embodiments, the structural model is used to accurately characterize a three-dimensional structure of the carrier. For example, it may be a CAD model generated based on the three-dimensional structure of the carrier by using a drafting software AutoCAD.

Step 730: registering the point cloud model with the structural model to determine an interior point in the point cloud model.

As an example, an ICP registration algorithm may be used to register the point cloud model and the structural model, and if a point in the point cloud model is successfully matched (i.e., there is a point in the structural model that corresponds to the point), the point is determined to be an interior point of the point cloud model.

Step 740: updating coordinates of the interior point in the point cloud based on coordinates corresponding to the interior point in the structural model.

As an example, three-dimensional coordinates corresponding to the interior point (which may be, for example, coordinates closest to the interior point) may be determined in the structural model, and the three-dimensional coordinates may be used as three-dimensional coordinates of the interior point in the point cloud, thereby obtaining point cloud data formed after the coordinates of the interior point are updated.

Step 750: constructing the offline map model.

In such embodiments, coordinates of an interior point in the point cloud are updated by registering a structural model of the carrier with the point cloud model, and the offline map model is constructed based on point cloud data formed after the coordinates of the interior point are updated. This helps further improve the accuracy of the offline map model.

Optionally, such embodiments shown in FIG. 7 may further include: registering the point cloud model with the structural model to determine an exterior point in the point cloud model, and removing the exterior point from the point cloud model.

Determining an exterior point in the point cloud model by registration and removing the exterior point can streamline the point cloud model, which helps improve the accuracy of the offline map model.

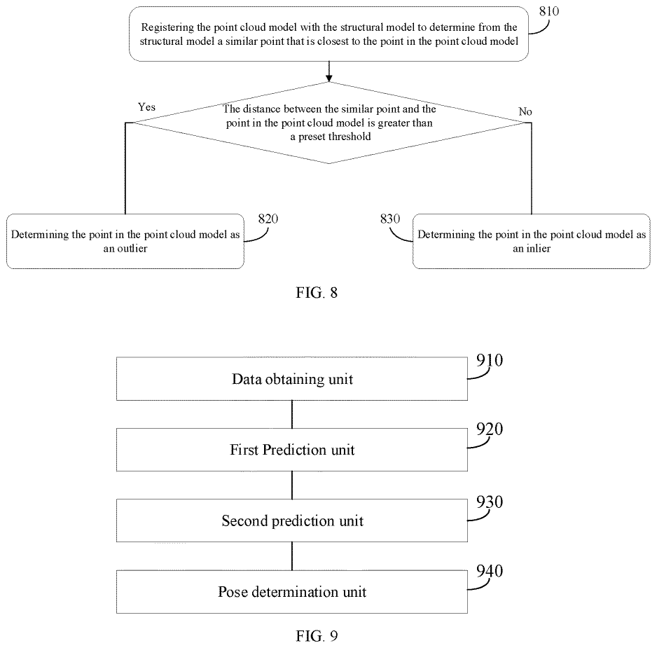

Further reference is made to FIG. 8, which illustrates a flow diagram of determining an interior point and an exterior point in some embodiments of constructing an offline map model in the present disclosure. As shown in FIG. 8, the process includes the following steps:

Step 810: registering the point cloud model with the structural model to determine from the structural model a similar point that is closest to the point in the point cloud model.

If the distance between the similar point and the point in the point cloud model is greater than a preset threshold, step 820 is executed. If the distance between the similar point and the point in the point cloud model is not greater than the preset threshold, step 830 is executed.

Step 820: determining the point in the point cloud model as an exterior point.

In such embodiments, if the distance between the similar point and the point in the point cloud model is greater than the preset threshold, indicating a matching failure, the point is determined as an exterior point.

Step 830: determining the point in the point cloud model as an interior point.

In such embodiments, if the distance between the similar point and the point in the point cloud model is not greater than the preset threshold, indicating a matching success, the point is determined as an interior point.

In such embodiments shown in FIG. 8, the interior point and the exterior point may be distinguished by the distance between the similar point and the point in the point cloud model, which helps improve the registration efficiency and matching accuracy between the point cloud model and the structural model.

In such embodiments shown in FIG. 8, the process may further include the following step: in response to the similar point in the structural model corresponding to the point in the point cloud model being located within a preset structure range of the carrier, removing the similar point from the point cloud model, wherein a point within the preset structure range represents a non-fixed point whose position is prone to change.

As an example, in the case where the carrier is a vehicle, a preset structure may be a vehicle window or glass, and the position of a point located on the vehicle window or glass is usually prone to change, and thus cannot accurately characterize spatial structure information of the carrier.

In such implementations, by determining a structure range in which the similar point corresponding to the point in the point cloud model is located, a non-fixed point in the point cloud model whose position is prone to change is identified and removed from the point cloud model. This can further streamline the point cloud model and improve the accuracy of determining a relative pose based on the offline map model.

The method for constructing an offline map model provided in embodiments of the present disclosure may be used to determine a relative pose.

In some optional embodiments, a method for determining a relative pose includes:

Step 540: at a current time, acquiring a current image by an image sensor.

Optionally, when the image sensor is located inside a movable carrier, the image sensor may be used to acquire an image from a current viewing angle to obtain the current image. It may be understood that the current image photographed by the image sensor should include at least an image of part of an area inside the carrier.

Step 550: predicting a second pose of the image sensor relative to the carrier at the current time based on the current image and a pre-constructed offline map model of the carrier.

Step 560: determining a relative pose of a head-mounted display device relative to the movable carrier based on the second pose.

Optionally, the method for constructing an offline map model provided in the above embodiments may be used in an extended reality system. The extended reality system includes a head-mounted display device provided with an image sensor and an apparatus for determining a relative pose. The apparatus for determining a relative pose determines a relative pose of the head-mounted display device relative to a carrier by using the method described in the above embodiments, and generates a projected image based on the relative pose.

In optional implementations, the method of constructing an offline map model provided in the above embodiments may also be used to determine a relative pose of a head-mounted display device having an image sensor and a motion sensor relative to a carrier. The carrier is provided with a target device, which is provided with an external sensor for acquiring motion data of the movable carrier. Optionally, a first pose of the head-mounted display device relative to the carrier at the current time may be predicted based on first inertial data and second inertial data, and the first pose may be fused with the second pose to determine a relative pose of the head-mounted display device relative to the carrier at the current time. Optionally, a first pose of the head-mounted display device relative to the carrier at the current time may also be predicted based on first inertial data, second inertial data, and a historical pose of the head-mounted display device relative to the carrier at the previous time, and the first pose may be fused with the second pose to determine a relative pose of the head-mounted display device relative to the carrier at the current time.

In some optional embodiments, after registering the structural model with the point cloud model and obtaining the relative pose, the method may further include: processing the relative pose and the structural model by using the head-mounted display device to generate a projected image.

In such embodiments, the projected image represents an image presented by the head-mounted display device to a user through an extended reality application. Performing image rendering processing based on the relative pose and the structural model to generate the projected image can improve the adaptation of the projected image to a moving state of the carrier, and reduce an adverse effect of carrier movement on the quality of the projected image, thereby improving an application effect of the head-mounted display device within the movable carrier.

In an optional implementation of any of the above embodiments, after obtaining the relative pose, the method may further include: using the relative pose as a historical pose of the head-mounted display device relative to the carrier at the next time.

As an example, the historical pose in step 320 may be a relative pose of the head-mounted display device relative to the carrier at the previous time determined through the above embodiments.

In such implementations, using the relative pose as a historical pose of the head-mounted display device relative to the carrier at the next time helps improve the calculation accuracy of a relative pose at the next time.

### Exemplary Apparatus

In the following, reference is made to FIG. 9, which shows a schematic structural diagram of some embodiments of an apparatus for determining a relative pose in the present disclosure, applied to a head-mounted display device. The head-mounted display device is provided with an image sensor and a first inertial measurement unit. The head-mounted display device is located inside a movable carrier. The carrier is provided with a second inertial measurement unit. The apparatus includes: a data obtaining unit 910 configured to, at a current time, obtain a current image, first inertial data, and second inertial data respectively by using the image sensor, the first inertial measurement unit, and the second inertial measurement unit; a first prediction unit 920 configured to predict a first pose of the head-mounted display device relative to the carrier at the current time based on the first inertial data, the second inertial data, and a historical pose of the head-mounted display device relative to the carrier at the previous time; a second prediction unit 930 configured to predict a second pose of the head-mounted display device relative to the carrier at the current time based on the current image and a pre-constructed offline map model; and a pose determination unit 940 configured to fuse the first pose with the second pose, and determine a relative pose of the head-mounted display device relative to the carrier at the current time.

In some implementations, the second prediction unit 920 includes: a first obtaining module configured to obtain the offline map model of the carrier, the offline map model including predetermined reference feature points of the carrier and reference visual descriptors thereof; a first extraction module configured to extract a 2D feature point and a corresponding visual descriptor from the current image; a feature point matching module configured to match the visual descriptor corresponding to the 2D feature point with the reference visual descriptors to determine a reference feature point corresponding to the 2D feature point from the offline map model; and a pose determination module configured to determine the second pose based on the 2D feature point and the reference feature point corresponding thereto.

In some implementations, the feature point matching module is further configured to: determine the reference feature point corresponding to the 2D feature point based on degrees of similarity between the visual descriptor corresponding to the 2D feature point and the reference visual descriptors in the offline map model, respectively.

In some implementations, the apparatus further includes a model construction unit including: a second obtaining module configured to obtain a sample image of the carrier and 3D coordinates of spatial points within the carrier; a model construction module configured to calculate a point cloud model of the carrier based on the obtained 3D coordinates of the spatial points within the carrier; and an association module configured to associate the sample image with the point cloud model, determine an image descriptor corresponding to a point in the point cloud model to obtain point cloud data with the image descriptor, thereby constructing the offline map model, wherein the point in the point cloud model and the image descriptor thereof are respectively used as a reference feature point and a reference visual descriptor.

In some implementations, the model construction unit further includes: a third obtaining module configured to obtain a structural model of the carrier; a registration module configured to register the point cloud model with the structural model to determine an interior point in the point cloud model; and an updating module configured to update coordinates of the interior point in the point cloud based on coordinates corresponding to the interior point in the structural model.

In some implementations, the model construction unit further includes: an exterior point identification module configured to register the point cloud model with the structural model to determine an exterior point in the point cloud data model; and an exterior point removal module configured to remove the exterior point from the point cloud model.

In some implementations, the interior point and the exterior point are determined in the following manner: registering the point cloud model with the structural model to determine from the structural model a similar point that is closest to the point in the point cloud model; and if a distance between the similar point and the point in the point cloud model is greater than a preset threshold, determining the point in the point cloud model as the exterior point; or if the distance between the similar point and the point in the point cloud model is not greater than the preset threshold, determining the point in the point cloud model as the interior point.

In some implementations, the apparatus further includes a filtering unit configured to: in response to the similar point in the structural model corresponding to the point in the point cloud model being located within a preset structure range of the carrier, remove the similar point from the point cloud model, wherein a point within the preset structure range represents a non-fixed point whose position is prone to change.

In some implementations, the sample image includes images obtained by photographing the carrier from a plurality of viewing angles and/or in a plurality of lighting environments; and the second obtaining module is further configured to: determine image descriptors corresponding to the point in the point cloud model respectively from a plurality of viewing angles and/or in a plurality of lighting environments to obtain the point cloud data.

In some implementations, the apparatus further includes a rendering unit configured to: process the relative pose and the structural model by using the head-mounted display device to generate a projected image.

In some implementations, the apparatus further includes a historical pose determination unit configured to: use the relative pose as a historical pose of the head-mounted display device relative to the carrier at the next time.

### Exemplary Electronic Device

In addition, an embodiment of the present disclosure further provides an electronic device, including:
a memory configured to store a computer program; and
a processor configured to execute the computer program stored in the memory, wherein the computer program, when executed, implements the method for determining a relative pose according to any of the above embodiments of the present disclosure.

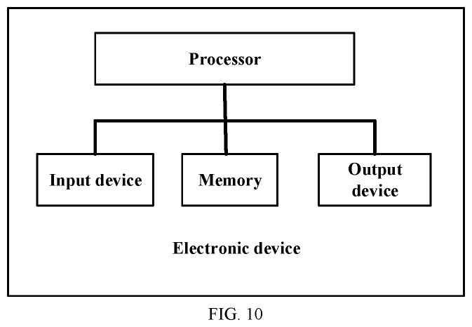

FIG. 10 is a schematic structural diagram of an application embodiment of an electronic device of the present disclosure. An electronic device according to an embodiment of the present disclosure will be described below with reference to FIG. 10. As shown in FIG. 10, the electronic device includes one or more processors and a memory.

The processor may be a central processing unit (CPU) or another form of processing unit having data processing capabilities and/or instruction execution capabilities, and may control other components in the electronic device to perform desired functions.

The memory may include one or more computer program products. The computer program products may include various forms of computer-readable storage media, such as a volatile memory and/or a non-volatile memory. The volatile memory may, for example, include random access memory (RAM) and/or a cache memory (cache), etc. The non-volatile memory may, for example, include a read-only memory (ROM), a hard disk, a flash memory, etc. One or more computer program instructions may be stored in the computer-readable storage medium, and the processor may execute the program instructions to implement the method for determining a relative pose in embodiments of the present disclosure described above and/or other desired functions.

In an example, the electronic device may further include an input device and an output device. The components are interconnected via a bus system and/or other form of connecting mechanisms (not shown).

In addition, the input device may further include, for example, a keyboard, a mouse, and the like.

The output device may output various information to the outside, including determined distance information, direction information, etc. The output device may include, for example, a display, a speaker, a printer, and a communications network and a remote output device connected thereto, etc.

Of course, for simplicity, only some of the components of the electronic device relevant to the present disclosure are shown in FIG. 10, while components such as buses, input/output interfaces, and the like are omitted. In addition, depending on a specific application, the electronic device may further include any other appropriate components.

In addition to the method and device described above, embodiments of the present disclosure may also be a computer program product including computer program instructions. The computer program instructions, when executed by a processor, cause the processor to execute the steps of the method for determining a relative pose according to various embodiments of the present disclosure as described in the above section of this specification.

The computer program product may use any combination of one or more programming languages to write program code for performing operations of the embodiments of the present disclosure. The programming languages include an object-oriented programming language such as Java or C++, and also include a conventional procedural programming language, such as “C” language or a similar programming language. The program code may be executed entirely on a user's computing device, partly on a user's device, as an independent software package, partly on a user's computing device and partly on a remote computing device, or entirely on a remote computing device or server.

In addition, embodiments of the present disclosure may also be a computer-readable storage medium configured to store computer program instructions. The computer program instructions, when executed by a processor, cause the processor to execute the steps of the method for determining a relative pose according to various embodiments of the present disclosure as described in the above section of this specification.

The computer-readable storage medium may be any combination of one or more readable media. The readable medium may be a readable signal medium or a readable storage medium. The readable storage medium may include, for example, but is not limited to, an electronic, magnetic, optical, electromagnetic, infrared, or semiconductor system, apparatus or device, or any combination thereof. More specific examples (a non-exhaustive list) of the readable storage medium include: an electrical connection with one or more conducting wires, a portable disk, a hard disk, a random access memory (RAM), a read only memory (ROM), an erasable programmable read only memory (EPROM or flash memory), an optical fiber, a portable compact disk read only memory ((CD-ROM), an optical storage device, a magnetic storage device, or any suitable combination thereof.

Those of ordinary skill in the art can understand that all or part of the steps in the above method embodiment may be implemented by hardware related to program instructions. The aforementioned program may be stored in a computer-readable storage medium. When the program is executed, the steps included in the above method embodiment are executed. The aforementioned storage medium includes: a ROM, a RAM, a magnetic disk or optical disk, or any of various media capable of storing program codes.

Basic principles of the present disclosure are described above in conjunction with specific embodiments. However, it is to be noted that the advantages, strengths, effects, and the like mentioned in the present disclosure are only examples and not limitations, and these advantages, strengths, effects, and the like should not be regarded as indispensable for the embodiments of the present disclosure. In addition, the specific details in the above disclosure are only for the purposes of exemplification and ease of understanding, and are not limiting. The above details do not constrain the present disclosure to be necessarily implemented with the above specific details.

The embodiments in the specification are described in a progressive manner. Each embodiment focuses on differences from other embodiments. For the same and similar parts between the embodiments, reference can be made to each other. A system embodiment, which substantially corresponds to a method embodiment, is described relatively simply, and for its relevant parts, reference may be made to parts of description of the method embodiment.

Block diagrams of devices, apparatuses, equipment, and systems involved in the present disclosure are only used as illustrative examples and are not intended to require or imply that they are necessarily connected, arranged, or configured in the manner illustrated in the block diagrams. As will be recognized by those skilled in the art, these devices, apparatuses, equipment, and systems may be connected, arranged, or configured in any manner. Words such as “include”, “comprise”, “have”, etc. are open-ended terms, mean “include but not limited to” and may be used interchangeably. The words “or” and “and” as used herein refer to the words “and/or”, and may be used interchangeably therewith unless the context clearly indicates otherwise. The word “such as” as used herein refers to the phrase “such as, but not limited to”, and may be used interchangeably therewith.

The method and apparatus of the present disclosure may be implemented in many ways. For example, the method and apparatus of the present disclosure may be implemented by software, hardware, firmware, or any combination of software, hardware, and firmware. The above order for the steps of the described method is only for an illustrative purpose, and the steps of the methods of the present disclosure are not limited to the order specifically described above, unless otherwise specified. Additionally, in some embodiments, the present disclosure may also be implemented as programs recorded in a recording medium. The programs include machine-readable instructions for implementing the method according to the present disclosure. Thus, the present disclosure also covers a recording medium that stores programs for performing the method according to the present disclosure.

It is also to be noted that in the apparatus, device, and method of the present disclosure, the components or steps are decomposable and/or recombinable. These decompositions and/or recombinations should be considered as equivalents of the present disclosure.

The above description of the disclosed aspects is provided to enable any person skilled in the art to carry out or use the present disclosure. Various modifications to these aspects are very apparent to those skilled in the art, and general principles defined herein may be applied to other aspects without departing from the scope of the present disclosure. Accordingly, the present disclosure is not intended to be limited to the aspects illustrated herein, but rather in accordance with the broadest scope consistent with the principles and novel features disclosed herein.

The above description has been made for purposes of illustration and description. In addition, this description is not intended to limit the embodiments of the present disclosure to the forms disclosed herein. Although a plurality of example aspects and embodiments have been discussed above, certain variations, modifications, changes, additions, and sub-combinations thereof would occur to those skilled in the art.

1. A method for determining a relative pose, which is used for determining a relative pose of a head-mounted display device relative to a movable carrier, the head-mounted display device being provided with an image sensor and a first motion sensor, the movable carrier is provided with a second motion sensor, and the head-mounted display device being located inside the movable carrier, the method comprising:
acquiring a current image, first inertial data, and second inertial data respectively by the image sensor, the first motion sensor, and the second motion sensor, at a current time;
predicting a first pose of the head-mounted display device relative to the movable carrier based on the first inertial data and the second inertial data;
predicting a second pose of the head-mounted display device relative to the movable carrier at the current time, based on the current image and a pre-constructed offline map model of the movable carrier;
fusing the first pose with the second pose; and
determining the relative pose of the head-mounted display device relative to the movable carrier at the current time.

2. (canceled)

3. The method according to claim 1, wherein predicting a first pose of the head-mounted display device relative to the movable carrier based on the first inertial data and the second inertial data comprises: predicting the first pose of the head-mounted display device relative to the movable carrier at the current time based on the first inertial data, the second inertial data, and a historical pose of the head-mounted display device relative to the movable carrier at the previous time.

4. The method according to claim 1, wherein predicting a second pose of the head-mounted display device relative to the movable carrier at the current time based on the current image and a pre-constructed offline map model comprises:
obtaining the offline map model of the movable carrier, the offline map model comprising predetermined reference feature points of the movable carrier and reference visual descriptors thereof;
extracting a 2D feature point and a corresponding visual descriptor from the current image;
matching the visual descriptor corresponding to the 2D feature point with the reference visual descriptors to determine a reference feature point corresponding to the 2D feature point from the offline map model; and
determining the second pose based on the 2D feature point and the reference feature point corresponding thereto.

5. The method according to claim 4, wherein determining a reference feature point corresponding to the 2D feature point from the offline map model based on the visual descriptor corresponding to the 2D feature point and the reference visual descriptors comprises:
determining the reference feature point corresponding to the 2D feature point based on degrees of similarity between the visual descriptor corresponding to the 2D feature point and the reference visual descriptors in the offline map model, respectively.

6. The method according to claim 1, wherein the offline map model is constructed in the following manner:
obtaining a sample image of the movable carrier and 3D coordinates of spatial points in the movable carrier;
calculating a point cloud model of the movable carrier based on the obtained 3D coordinates of the spatial points in the movable carrier; and
associating the sample image with the point cloud model; and
determining an image descriptor corresponding to a point in the point cloud model to obtain point cloud data with the image descriptor, thereby constructing the offline map model,
wherein the point in the point cloud model and the image descriptor thereof are respectively used as a reference feature point and a reference visual descriptor.

7. The method according to claim 6, wherein, after obtaining point cloud data with the image descriptor and before constructing the offline map model, the method further comprises:
obtaining a structural model of the movable carrier;
registering the point cloud model with the structural model to determine an interior point in the point cloud model; and
updating coordinates of the interior point in the point cloud based on coordinates corresponding to the interior point in the structural model.

8. The method according to claim 7, wherein the method further comprises:
registering the point cloud model with the structural model to determine an exterior point in the point cloud data; and
removing the exterior point from the point cloud model.

9. The method according to claim 8, wherein the interior point and the exterior point are determined in the following manner:
registering the point cloud model with the structural model to determine from the structural model a similar point that is closest to the point in the point cloud model; and
if a distance between the similar point and the point in the point cloud model is greater than a preset threshold, determining the point in the point cloud model as the exterior point; or
if a distance between the similar point and the point in the point cloud model is not greater than the preset threshold, determining the point in the point cloud model as the interior point.

10. The method according to claim 9, wherein the method further comprises: in response to the similar point in the structural model corresponding to the point in the point cloud model being located within a preset structure range of the movable carrier, removing the similar point from the point cloud model, wherein a point within the preset structure range represents a non-fixed point whose position is prone to change.

11. The method according to claim 6, wherein the sample image comprises images obtained by photographing the movable carrier from a plurality of viewing angles and/or in a plurality of lighting environments; and
determining an image descriptor corresponding to a point in the point cloud model to obtain point cloud data with the image descriptor comprises:
determining image descriptors corresponding to the point in the point cloud model respectively from a plurality of viewing angles and/or in a plurality of lighting environments to obtain the point cloud data.

12. The method according to claim 7, further comprising:
processing the relative pose and the structural model by the head-mounted display device to generate a projected image.

13. The method according to claim 3, further comprising:
using the relative pose as a historical pose of the head-mounted display device relative to the carrier at next time.

14. An extended reality system, comprising a head-mounted display device a first motion sensor, a second motion sensor arranged in a movable carrier, and an apparatus for determining a relative pose of a head-mounted display device relative to the movable carrier, wherein the head-mounted display device is provided with an image sensor, and the head-mounted display device being located inside the movable carrier,
the extended reality system is configured to:
acquire a current image, first inertial data and second inertial data respectively by the image sensor, the first motion sensor and the second motion sensor, at a current time;
predict a first pose of the head-mounted display device relative to the movable carrier based on the first inertial data and the second inertial data;
predict a second pose of the head-mounted display device relative to the movable carrier at the current time, based on the current image and a pre-constructed offline map model of the movable carrier;
fuse the first pose with the second pose; and
determine the relative pose of the head-mounted display device relative to the movable carrier at the current time.

15. (canceled)

16. The extended reality system according to claim 14, wherein the extended reality system is further configured to:
predict the first pose of the head-mounted display device relative to the movable carrier at the current time based on the first inertial data, the second inertial data, and a historical pose of the head-mounted display device relative to the movable carrier at the previous time.

17. The extended reality system according to claim 14, wherein the extended reality system is further configured to:
obtain the offline map model of the movable carrier, the offline map model comprising predetermined reference feature points of the movable carrier and reference visual descriptors thereof;
extract a 2D feature point and a corresponding visual descriptor from the current image;
match the visual descriptor corresponding to the 2D feature point with the reference visual descriptors to determine a reference feature point corresponding to the 2D feature point from the offline map model; and
determine the second pose based on the 2D feature point and the reference feature point corresponding thereto.

18. The extended reality system according to claim 17, wherein the extended reality system is further configured to:
determine the reference feature point corresponding to the 2D feature point based on degrees of similarity between the visual descriptor corresponding to the 2D feature point and the reference visual descriptors in the offline map model, respectively.

19. The extended reality system according to claim 14, wherein the offline map model is constructed in the following manner:
obtaining a sample image of the carrier and 3D coordinates of spatial points in the movable carrier;
calculating a point cloud model of the movable carrier based on the obtained 3D coordinates of the spatial points in the movable carrier; and
associating the sample image with the point cloud model; and
determining an image descriptor corresponding to a point in the point cloud model to obtain point cloud data with the image descriptor, thereby constructing the offline map model,
wherein the point in the point cloud model and the image descriptor thereof are respectively used as a reference feature point and a reference visual descriptor.

20. The extended reality system according to claim 19, wherein the sample image comprises images obtained by photographing the movable carrier from a plurality of viewing angles and/or in a plurality of lighting environments; and
determining an image descriptor corresponding to a point in the point cloud model to obtain point cloud data with the image descriptor comprises:
determining image descriptors corresponding to the point in the point cloud model respectively from a plurality of viewing angles and/or in a plurality of lighting environments to obtain the point cloud data.
